(19) United States
(12) Patent Application Publication
(10) Pub. No.: US 2023/0012322 A1
(43) Pub. Date: Jan. 12, 2023

(54) METHOD FOR REAL-TIME COMMUNICATION CONNECTION, SERVER AND STORAGE MEDIUM

(71) Applicant: WANGSU SCIENCE & TECHNOLOGY CO., LTD., Shanghai (CN)

(72) Inventors: Xiangxiang CHEN, Shanghai (CN); Xiaochuan ZHUANG, Shanghai (CN)

(21) Appl. No.: 17/895,428

(22) Filed: Aug. 25, 2022

Related U.S. Application Data
(63) Continuation of application No. PCT/CN2021/110611, filed on Aug. 4, 2021.

(30) Foreign Application Priority Data
Jun. 30, 2021 (CN) 202110735839.X

(51) Int. Cl. H04L 65/1069

(52) U.S. Cl. CPC H04L 65/1069; H04L 69/164

(57) ABSTRACT

Embodiments of the present disclosure relates to the field of communication technology, which provide a method for real-time communication connection, a server, and a storage medium. The server is configured to have service processes in one-to-one correspondence with UDP ports. After receiving each respective SDP request sent by each of at least one client for resource negotiation from a TCP port of the server, the service processes send each respective SDP response to each of the at least one client based on the each respective SDP request. The each respective SDP response carries information of a UDP port corresponding to a service process that processes the each respective SDP request. The service process receives a UDP connection request sent by a client from the UDP port corresponding to the service process, and establishes a UDP connection by calling a Connect function to implement RTC connection.

### CROSS REFERENCE TO RELATED APPLICATIONS

The present disclosure is a continuation of PCT Patent Application No. PCT/CN2021/110611, filed Aug. 4, 2021, which claims priority to Chinese patent application No. 202110735839.X, filed Jun. 30, 2021, each of which is incorporated by reference herein in its entirety.

### TECHNIC FIELD

The embodiments of the present disclosure relate in general to communication technology, and more specifically to a method for real-time communication connection, a server and a non-transitory storage medium.

### BACKGROUND

Real-time communication (RTC) was first proposed by Google, which uses webrtc for web video conferencing, uses a user datagram protocol (UDP) as a transport layer protocol, and is aimed at a peer-to-peer (P2P) mode between clients, so that ports are dynamically changed and the ports are dynamically allocated for each connection. Because the communication is between the clients, a conventional method is to open a plurality of ports on a client side, each of the plurality of ports corresponding to one of other different clients connected to this client to distinguish the different clients. Since there are not many other clients that are connected at the same time, it is not a big problem to dynamically configure ports for each of the different clients connected to the client on the client side.

When a content delivery network (CDN) in live broadcast is gradually connected with the RTC, the port opening mode begins to become an issue requiring close attention. On a server side, a server may need to connect thousands of clients at the same time for live broadcast on the Internet. If the conventional method in which each client is configured with one port is still adopted, the number of ports to be configured is large, thereby resulting in problems such as difficulties in port maintenance, vulnerability to attack, and limited number of clients able to be served, etc., due to the large number of ports.

### SUMMARY

Embodiments of the present disclosure are intended to provide a method for real-time communication connection, a server and a non-transitory storage medium, which effectively solve problems in a conventional RTC method of poor security and difficulty in operation and maintenance caused by opening a large number of ports in order to adapt to CDN services.

Embodiments of the present disclosure provide a method for real-time communication connection, applied to service processes started on a server, wherein the server is configured to allocate user datagram protocol (UDP) ports for binding to the service processes, and the service processes are in one-to-one correspondence with the UDP ports, the method including: receiving each respective session description protocol (SDP) request sent by each of at least one client for resource negotiation from a transmission control protocol (TCP) port of the server; sending each respective SDP response to each of the at least one client based on the each respective SDP request, wherein the each respective SDP response carries information of a UDP port corresponding to a service process that processes the each respective SDP request; receiving a UDP connection request sent by a client from the UDP port corresponding to the service process; and establishing a UDP connection by calling a Connect function.

Embodiments of the present disclosure further provide a server including: at least one processor; and memory communicatively coupled to the at least one processor; wherein the memory stores instructions executable by the at least one processor which, when executed by the at least one processor, cause the at least one processor to perform the method for real-time communication connection described above.

Embodiments of the present disclosure further provide a non-transitory computer readable storage medium storing a computer program that, when executed by at least one processor, cause the at least one processor to perform the method for real-time communication connection described above.

In the embodiments of the present disclosure, the server is configured to have the service processes in one-to-one correspondence with the UDP ports. The service processes receive each respective SDP request sent by each of at least one client for resource negotiation from the TCP port of the server, and send each respective SDP response to each of the at least one client based on the each respective SDP request. The each respective SDP response carries information of the UDP port corresponding to the service process that processes the each respective SDP request. The service process receives the UDP connection request sent by the client corresponding to the each respective SDP response from the UDP port and establishes the UDP connection by calling the Connect function to realize the RTC connection. Since service processes are pre-configured in one-to-one correspondence with the UDP ports in the method of the present disclosure, so that all UDP requests of all clients received by the same UDP port are able to be transported to the same service process to realize servicing a plurality of clients with limited ports, so as to solve poor security and difficulty in operation and maintenance caused by opening a large number of ports.

In some embodiments, since the service processes are in one-to-one correspondence with the UDP ports, the UDP requests from the same client are prevented from being sent to different service processes. Therefore, the service processes are prevented from being unable to perform service processing due to being unable to obtain relevant data from other different processes.

In some embodiments, since the service process processing the SDP request carries the UDP port corresponding to this service process in the SDP response, the SDP request and UDP request from the same client are transmitted to the same service process. Therefore, the service processes are prevented from being unable to perform service processing due to being unable to obtain relevant data from other different processes when these two types of requests are routed to different service processes.

In some embodiments, since the UDP connection is established by calling the Connect function, stateful connections are able to be made to different UDP requests from the same client.

In some embodiments, the service process processing the SDP request is one of the service processes locally started on the server which is selected by the server based on a load balancing principle. Through load balancing, the RTC connections of all the clients are able to be evenly distributed to each of the service processes. In this way, the service volume of subsequent UDP requests of the service processes is balanced.

In some embodiments, the each respective SDP response carries first verification information generated by the service process, and the UDP connection request carries second verification information; and before establishing the UDP connection by calling the Connect function, the method further includes: verifying the second verification information based on the first verification information; and in response to the verification succeeding, performing the establishment of the UDP connection by calling the Connect function. The verification information is set to ensure the security and validity of the UDP connection.

In some embodiments, the each respective SDP request includes offer information carried in a hyper text transfer protocol (HTTP) request sent by each of the at least one client, and the HTTP request further includes related information of the each respective SDP request initiated by each of the at least one client this time; and wherein the each respective SDP response includes answer information carried in a HTTP response sent by the service process, and the first verification information includes attribute information included in the answer information; and after receiving the each respective SDP request, the method further includes: creating a mapping entry corresponding to the each respective SDP request, wherein the mapping entry includes related information of the each respective SDP request and the first verification information. By creating the mapping entry, the related information and verification information of the SDP request are mapped, so as to facilitate verifying information of the SDP request and subsequently querying the related information of the SDP request.

In some embodiments, verifying the second verification information based on the first verification information includes: in response to a mapping entry corresponding to the second verification information existing in the created mapping entry, determining that the verification succeeds.

In some embodiments, the first verification information includes a timestamp of generating the first verification information, a service process identifier, and a real-time communication (RTC) connection number. This generation mode guarantees the uniqueness of the verification information to the maximum limit.

In some embodiments, the related information of the each respective SDP request includes information of a domain name and a streaming name of a streaming media that is requested.

In some embodiments, the offer information includes client-supported audio-video coding parameters, and the answer information includes audio-video coding parameters fed back by the server; and the audio-video coding parameters fed back by the server are live audio-video coding parameters acquired by the server from a live broadcast server based on the information of the domain name and the streaming name in the HTTP request.

In some embodiments, the UDP connection request includes a binding request based on a simple traversal of UDP through network address translation (STUN) protocol, and the second verification information includes STUN authentication information carried in the binding request. The server verifies the binding request of the STUN protocol through the second verification information.

In some embodiments, establishing the UDP connection by calling the Connect function includes: creating a unique file descriptor of the UDP connection; binding the unique file descriptor to the UDP port corresponding to the service process; associating 5-tuple information corresponding to the UDP connection through reversely connecting an address of a peer end; and associating the 5-tuple information corresponding to the UDP connection with the service process corresponding to the UDP connection based on the unique file descriptor to complete the UDP connection. By binding the file descriptor to the 5-tuple information, the file descriptor is able to be used to distinguish the UDP connections of different clients, and ensure that the connected UDP packets are sent and received normally after the service process reloads, so that a plurality of UDP packets belonging to the same request are not confused.

In some embodiments, associating the 5-tuple information corresponding to the UDP connection with the service process corresponding to the UDP connection based on the unique file descriptor to complete the UDP connection includes: setting the unique file descriptor as a read-write event monitored by the service process, and setting a read-write event callback function of the unique file descriptor to receive and process subsequent UDP requests corresponding to the unique file descriptor through the read-write event callback function.

### BRIEF DESCRIPTION OF THE DRAWINGS

In order to illustrate the technical solutions in the embodiments of the present disclosure more clearly, the accompanying drawings used in the description of the embodiments are briefly described below. It is apparent that the drawings in the following description are only some embodiments of the present disclosure. For those of ordinary skills in the art, other drawings may also be obtained according to these drawings without any creative effort.

FIG. 1 is a specific flowchart of a method for real-time communication connection according to a first embodiment of the present disclosure.

FIG. 2 is a specific flowchart of a method for real-time communication connection according to a second embodiment of the present disclosure.

FIG. 3 is another specific flowchart of the method for real-time communication connection according to the second embodiment of the present disclosure.

FIG. 4 is a schematic structural diagram of a server according to a third embodiment of the present disclosure.

### DETAILED DESCRIPTION OF THE EMBODIMENTS

In order to make the objectives, technical solutions and advantages of the present disclosure clearer, embodiments of the present disclosure are described in details with reference to the accompanying drawings. Those of ordinary skill in the art should appreciate that many technical details have been proposed in various embodiments of the present disclosure for the reader to better understand the present disclosure. However, the technical solutions claimed in the appended claims are also able to be realized even without these technical details and various changes and modifications based on the following embodiments.

Unlike other protocol requests, RTC involves interaction processes of two protocol requests. A first protocol request interaction process is a session description protocol (SDP) process, i.e., signaling exchange. This signaling exchange process is usually performed using hyper text transfer protocol (HTTP) (or other protocols such as web socket). HTTP is based on transmission control protocol (TCP) and needs to perform information transmission through a TCP port on the device. A second protocol request interaction process is a connection process of user datagram protocol (UDP). This process mainly includes processing of a simple traversal of UDP over NATs (STUN) request, a datagram transport layer security (DTLS) request and a real-time protocol/real-time control protocol (RTP/RTCP) request. Therefore, HTTP and subsequent UDP requests are ensured to be transmitted to the same process, or are transmitted to different processes as long as related information of previous signaling interaction, including streaming names, is able to be read.

The entire interaction process of RTC is described as follows.

Firstly, SDP signaling interaction is performed based on TCP. A client initiates a ‘sdp offer’ request, and a server feeds back a ‘sdp answer’ response to perform resource negotiation for related information of subsequent UDP connection establishment.

Secondly, UDP requests are processed based on a RTC protocol. The processing first involves the STUN request, then the DTLS handshake, and finally the transmission of audio-video data RTC packets. However, UDP is a connectionless protocol, and each data packet is independent. There is no concept of connection in each data packet, so a conventional practice is to establish different ports through UDP to distinguish different clients. In this way, a request sent by which client is able to be identified by a port from which the data packet is received, so that a plurality of different clients are able to be served by the server. However, a large number of ports need to be opened on the server at the same time to correspond to different clients when the concurrency is relatively large, so there are risks in operation, maintenance and security.

To solve this problem, embodiments of the present disclosure provide a method for implementing RTC connection in a manner that one process corresponds to one port. In this method, each process is independent and does not require inter-process communication. All clients requesting to the same process use the same port, and different processes use different ports. In this way, a maximum number of ports opened on the server is the same as the number of the processes. Since the number of the processes is generally not very large, this method is also referred to as a limited port method, that is, there is no need to open as many ports (i.e., one port for one client) as in the conventional method.

When the signaling interaction is performed based on HTTP, a port number allocated to each of the processes is notified to the client through a SDP message, and subsequent UDP requests of the client are sent to this port through STUN, DTLS, and RTP/RTCP, that is, all requests of the same client are transmitted to the same process, and information such as steaming names stored in the previous signaling interaction is able to be obtained in the same process space, without being interactively obtained through the inter-process communication (IPC).

A first embodiment of the present disclosure relates to a method for real-time communication (RTC) connection, which is applied to a server. The server is configured to allocate UDP ports for binding to service processes started on the server, so that the service processes are in one-to-one correspondence with the UDP ports. The service processes are processes that actually processes service requests, not main processes configured to transmit the service requests or scheduling processes responsible for load balancing.

Specifically, when service processes are started, the server assigns UDP ports to the service processes through a preconfigured port range and binds the service processes to the UDP ports, one service process corresponding to one UDP port, so that the UDP ports are within a controllable range. For example, if the preconfigured UDP port range is 16000 to 16030, and 30 UDP ports are provided for 7 service processes, the number of UDP ports available for each process is 4 (i.e., 30/7≈4). For each service process, only one UDP port is used each time the service process is started, which aims to avoid continuing to bind a second UDP port when a first UDP port fails to be bound. For example, a first service process corresponds to a port 16000, a second service process corresponds to a port 16004, and a third service process corresponds to a port 16008. If it is not desired to request for too many ports to be released, it is proper to request for the same number of ports as the number of processes. For example, with respect to 7 service processes, only 7 UDP ports need to be requested. At the same time, ‘reuse-port’ needs to be set, so that multiple processes are able to coexist with old and new in a reload mode without affecting data interaction.

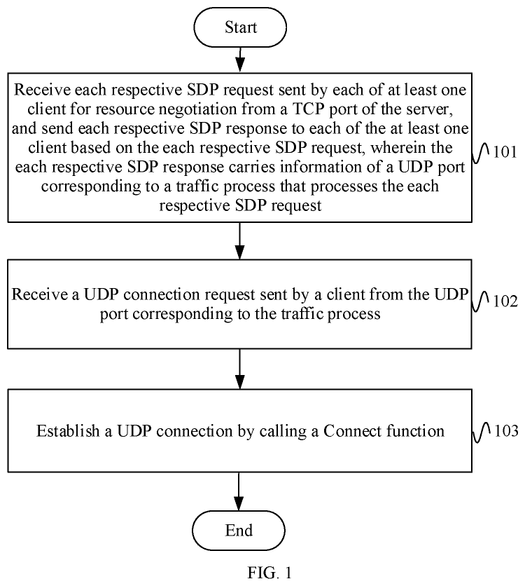

As shown in FIG. 1, the method for real-time communication connection in the embodiments of the present disclosure includes the following operations.

In 101, each respective SDP request sent by each of at least one client for resource negotiation is received from a TCP port of the server, and each respective SDP response is sent to each of the at least one client based on the each respective SDP request. The each respective SDP response carries information of a UDP port corresponding to a service process that processes the each respective SDP request.

Specifically, the server is provided with the TCP port for receiving an HTTP request sent by the client. The client initiates the SDP request through an HTTP protocol for resource negotiation with the server, i.e., a signaling interaction process. A purpose of this signaling interaction process is to perform resource negotiation for related information of subsequent UDP connection establishment. In addition, the server a port on which the client sends a UDP connection request in the resource negotiation process, i.e., the UDP port. The server feeds back information of the indicated UDP port to the client in the SDP response.

After receiving the SDP request, the server selects, based on current loading conditions of all service processes on the server, a service process from all the service processes to receive and process a current SDP request sent by the client. That is, the service process that processes the SDP request is a service process selected by the server from locally started service processes based on a load balancing principle. The selected service process feeds back a UDP port corresponding to the selected service process to the client in the SDP response, so as to instruct the client to send the UDP request to the server through the UDP port, so that subsequent UDP requests are still able to be transmitted to the selected service process for processing.

In 102, the service process receives a UDP connection request sent by a client from the UDP port corresponding to the service process.

After receiving the SDP response fed back by the service process of the server, the client constructs the UDP connection request based on the resource negotiation result, and sends the UDP connection request to the server through the UDP port carried in the SDP response to start the UDP connection establishment.

In 103, the service process establishes a UDP connection by calling a Connect function.

Because UDP is a connectionless protocol and each data packet is independent and has no concept of connection, the method for establishing the UDP connection by calling the Connect function in the present disclosure is able to record related data of a new connection (e.g., 5-tuple information corresponding to the new connection) when the new connection is created, and query the recorded data to obtain a status of the previous connection when the UDP request is received again, thereby providing the stateless UDP connection with the effect of stateful connection.

In the embodiments of the present disclosure, the server is configured to have the service processes in one-to-one correspondence with the UDP ports. The service processes receive each respective SDP request sent by each of at least one client for resource negotiation from the TCP port of the server, and send each respective SDP response to each of the at least one client based on the each respective SDP request. The each respective SDP response carries information of the UDP port corresponding to the service process that processes the each respective SDP request. The service process receives the UDP connection request sent by the client corresponding to the each respective SDP response from the UDP port and establishes the UDP connection by calling the Connect function to realize the RTC connection. Since service processes are pre-configured in one-to-one correspondence with the UDP ports in the method of the present disclosure, so that all UDP requests of all clients received by the same UDP port are able to be transported to the same service process to realize servicing a plurality of clients with limited ports, so as to solve poor security and difficulty in operation and maintenance caused by opening a large number of ports.

In addition, since the service processes are in one-to-one correspondence with the UDP ports, the UDP requests from the same client are prevented from being sent to different service processes. Therefore, the service processes are prevented from being unable to perform service processing due to being unable to obtain relevant data from other different processes.

In addition, since the service process processing the SDP request carries the UDP port corresponding to this service process in the SDP response, the SDP request and UDP request from the same client are transmitted to the same service process. Therefore, the service processes are prevented from being unable to perform service processing due to being unable to obtain relevant data from other different processes when these two types of requests are routed to different service processes.

In addition, since the UDP connection is established by calling the Connect function, stateful connections are able to be made to different UDP requests from the same client.

A second embodiment of the present disclosure relates to a method for real-time communication connection. The second embodiment is an improvement on the first embodiment in that before establishing the UDP connection, the server generates verification information at the resource negotiation stage to verify the UDP connection request. That is, each respective SDP response fed back by the server carries first verification information generated by the service process (i.e., an operation 101′). Accordingly, the UDP connection request carries second verification information (i.e., an operation 102′). The second verification information is fed back by the server to the client. For distinguishing, the verification information in the SDP response is denoted as the first verification information, and the verification information carried in the UDP connection request is denoted as the second verification information.

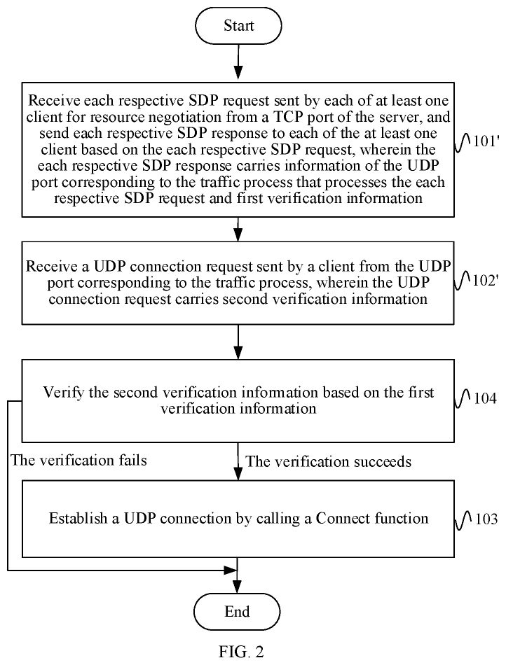

As shown in FIG. 2, the method embodiment further includes the following operations before the operation 103.

In 104, the second verification information is verified based on the first verification information. In response to the verification succeeding, the operation 103 of establishing the UDP connection by calling the Connect function is executed. The content of the first verification information is not limited in this embodiment.

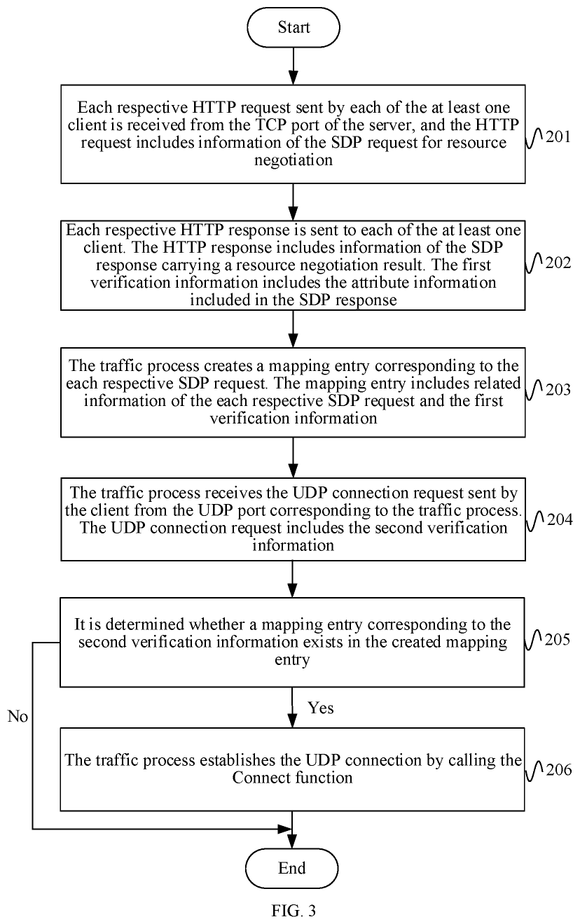

In an example, the SDP request includes ‘offer’ information carried in the HTTP request sent by the client, and the HTTP request further includes related information of the SDP request initiated by the client this time. For example, the related information includes information of a domain name and a streaming name of a streaming media requested by the client. The SDP response includes ‘answer’ information carried in the HTTP response sent by the service process. The first verification information includes attribute information included in the ‘answer’ information. In this embodiment, UDP connection requests subsequently sent by the same client are able to be verified by constructing a mapping entry corresponding to each SDP request. As shown in FIG. 3, the method for real-time communication connection of this embodiment includes the following operations.

In 201, each respective HTTP request sent by each of the at least one client is received from the TCP port of the server, and the HTTP request includes information of the SDP request for resource negotiation.

The ‘offer’ information includes client-supported audio-video coding parameters, such as H264 for video and opus for audio. In addition, the HTTP request further includes related information of the SDP request initiated by the client this time, e.g., information of the domain name and streaming name of the streaming media requested by the client.

In 202, each respective HTTP response is sent to each of the at least one client. The HTTP response includes information of the SDP response carrying a resource negotiation result. The first verification information includes the attribute information included in the ‘answer’ information (i.e., the SDP response).

The ‘answer’ information includes audio-video coding parameters fed back by the server.

The audio-video coding parameters fed back by the server are live audio-video coding parameters acquired by the server from a live broadcast server based on information of the domain name and the streaming name in the HTTP request.

Specifically, when the server constructs the ‘answer’ information, i.e., the SDP response, a mode of synchronizing back to origin is adopted in this embodiment in order to obtain real audio-video information of the streaming media requested by the client, i.e., synchronizing to initiate push-pull stream requests to a backend live broadcast server, and constructs corresponding audio-video coding parameters to be carried in the ‘answer’ information to respond to the client after obtaining the response of the backend live broadcast server.

Regarding a process of constructing the first verification information, the server receives the HTTP request including the ‘offer’ information, where the ‘offer’ information carries attribute information ‘ice-ufrag’ for identifying the client. Similarly, the ‘answer’ information returned by the server to the client also carries attribute information ‘ice-ufrag’ for identifying the server. The server uses the attribute information as the first verification information. When constructing the attribute information, the attribute information may include a field of ‘current timestamp_process PID_RTC_sequence number to distinguish RTC connections of different clients.

The ‘current timestamp’ is a timestamp for generating the attribute information (i.e., the first verification information), the ‘process PID’ is an identifier for a current service process, and the ‘RTC_sequence’ is a sequence number of a current RCT connection. When the sequence number reaches a maximum value, the sequence number is restarted from zero to ensure that the ‘ice_ufrag’ fed back by each service process to each client is unique at the current time.

In 203, the service process creates a mapping entry corresponding to the each respective SDP request. The mapping entry includes related information of the each respective SDP request and the first verification information.

Specifically, after generating the ‘ice-ufrag’, the server uses the ‘ice-ufrag’ as a key and the related information (information of the domain name and streaming name) of the SDP request as a value, generates a mapping entry (‘ice-ufrag’-related information of the SDP request), and adds the mapping entry to a pre-constructed mapping table.

In 204, the service process receives the UDP connection request sent by the client from the UDP port corresponding to the service process. The UDP connection request includes the second verification information.

After receiving the SDP response fed back by the service process of the server, the client constructs the UDP request based on the resource negotiation result, and sends the UDP connection request to the server through the UDP port carried in the SDP response to start the UDP connection establishment.

Specifically, after receiving the SDP response, the client extracts related parameters such as ‘ice_ufrag’ from the SDP response, and also obtains information of an IP address and a port (information of the IP address and UDP port of the server) in ‘ice candidate’. The UDP connection is then initiated to the server. A binding request of the STUN protocol is initiated first, and the binding request carries ‘username’ attribute, a format of the ‘username’ attribute is ‘server_ice_ufrag: client_ice_ufrag’, and the ‘server_ice_ufrag’ is the ‘ice_ufrag’ in the UDP response sent by the server. This ‘username’ attribute is carried in the UDP connection request, thus it is the second verification information. The second verification information is used as STUN authentication information in the binding request for the server to authenticate the binding request. The client sends the binding request to a specified IP address and port of the server (i.e., the IP address and port in ‘ice candidate’ in UDP response).

In 205, it is determined whether a mapping entry corresponding to the second verification information exists in the created mapping entry. In response to the mapping entry corresponding to the second verification information existing in the created mapping entry, it is determined that the verification succeeds and an operation 206 is performed.

Specifically, after receiving the STUN binding request sent by the client, the server parses the request to obtain the corresponding ‘username’ attribute, extracts the content on the left side of the colon ‘:’ in the ‘username’ attribute as the key, searches the mapping table for whether there is a mapping entry with ‘server_ice_ufrag’ as the key. In response to there being the mapping entry with ‘server_ice_ufrag’ as the key, it is determined that the verification succeeds, and a next operation is performed. In response to there being no mapping entry with ‘server_ice_ufrag’ as the key, it is determined that the verification fails, and the request ends.

In 206, the service process establishes the UDP connection by calling the Connect function.

In an example, the service process first creates a unique file descriptor for a current connection, binds the file descriptor to the UDP port corresponding to the service process, and associates 5-tuple information corresponding to the current connection through reversely connecting an address of a peer end, and associates the 5-tuple information corresponding to the current connection with the service process corresponding to the current connection based on the file descriptor to complete the UDP connection.

Specifically, the service process creates a file descriptor ‘fd’ for a current binding request, binds the ‘fd’ to the UDP port corresponding to the service process, and connects an IP address of the peer end (i.e., the client) to associate the 5-tuple information corresponding to the current connection. A pseudo code representation is shown as follows.

socket fd;
bind (fd, local_sockaddr, local_socklen);
connect (fd, remote_sockaddr, remote_socklen);

Then, the 5-tuple information and service process corresponding to the current connection are associated based on the file descriptor to complete the UDP connection.

In an example, the file descriptor is set as a read-write event monitored by the service process, and a read-write event callback function of the file descriptor is set to receive and process subsequent UDP requests corresponding to the file descriptor through the read-write event callback function.

Specifically, the ‘fd’ is added to ‘epoll’ of the service process to monitor a corresponding read-write event, and the read-write event callback function of the ‘fd’ needs to be added. The function is a unified entry function of the UDP request corresponding to the RTC connection. In this function, all UDP requests of the RTC connection are received and processed, and corresponding branches such as STUN, DTLS and SRTP\SRTCP are taken according to specific file descriptors.

Then, a STUN binding response is constructed to response to the client.

All subsequent UDP requests operate through read-write events registered by ‘fd’ bound to the UDP port to implement stateful connections of the UDP requests from a plurality of different clients.

In the embodiments of the present disclosure, the security and validity of the UDP connection are ensured by setting the verification information. The related information and verification information of the SDP request are mapped by creating the mapping entry, so as to facilitate verifying the SDP request and subsequently querying the related information of the SDP request. The stateful connection of UDP is implemented by setting the file descriptor to bind the 5-tuple information involved in the RTC connection.

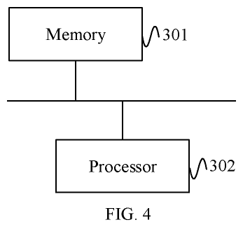

A third embodiment of the present disclosure relates to a server. As shown in FIG. 4, the server includes at least one processor 302 and memory 301 communicatively coupled to the at least one processor 302. The memory 301 stores instructions executable by the at least one processor 302 which, when executed by the at least one processor 302, cause the at least one processor 302 to perform any of the method embodiments described above.

The memory 301 and the at least one processor 302 are connected by means of bus, the bus may include any number of interconnected buses and bridges, and the bus connect various circuits of the at least one processor 302 and the memory 301 together. The bus may also connect together various other circuits such as peripheral devices, voltage regulators, and power management circuits, all of which are well known in the art, and therefore are not further described herein. A bus interface provides an interface between the bus and a transceiver. The transceiver may be an element or a plurality of elements, such as a plurality of receivers and transmitters for providing units for communicating with various other devices on a transmission medium. The data processed by the at least one processor 302 is transmitted over a wireless medium via antennas, and the antennas further receive the data and transmit the data to the at least one processor 302.

The at least one processor 302 is responsible for managing the bus and general processing, and may also provide various functions, including timing, peripheral interfaces, voltage regulation, power management, and other control functions. The memory 301 may be configured to store data used by the at least one processor 302 in performing operations.

A fourth embodiment of the present disclosure relates to a non-transitory computer readable storage medium storing a computer program. Any of the above method embodiments is implemented when the computer program is executed by at least one processor.

That is, it should be understood by those skilled in the art that all or a portion of the operations in the method embodiments described above may be implemented by a program instructing relevant hardware. The program is stored in a storage medium, which includes several instructions to cause a device (which may be a single chip microcomputer, a chip, or the like) or a processor to perform all or a portion of the operations of the method in the embodiments described herein. The foregoing storage medium includes a USB flash drive, a removable hard disk, read-only memory (ROM), random access memory (RAM), a magnetic disk, an optical disk, or any other medium that is able to store program codes.

Those of ordinary skill in the art should appreciate that the above embodiments are specific embodiments of the present disclosure, and that various changes may be made in form and detail in practical application without departing from the spirit and scope of the present disclosure.

What is claimed is:

1. A method for real-time communication connection, applied to service processes started on a server, wherein the server is configured to allocate user datagram protocol (UDP) ports for binding to the service processes, and the service processes are in one-to-one correspondence with the UDP ports, the method comprising:
receiving each respective session description protocol (SDP) request sent by each of at least one client for resource negotiation from a transmission control protocol (TCP) port of the server;
sending each respective SDP response to each of the at least one client based on the each respective SDP request, wherein the each respective SDP response carries information of a UDP port corresponding to a service process that processes the each respective SDP request;
receiving a UDP connection request sent by a client from the UDP port corresponding to the service process; and
establishing a UDP connection by calling a Connect function.

2. The method according to claim 1, wherein the service process processing the each respective SDP request is one of the service processes locally started on the server which is selected by the server based on a load balancing principle.

3. The method according to claim 1, wherein the each respective SDP response carries first verification information generated by the service process, and the UDP connection request carries second verification information; and
before establishing the UDP connection by calling the Connect function, the method further comprises:
verifying the second verification information based on the first verification information; and
in response to the verification succeeding, performing the establishment of the UDP connection by calling the Connect function.

4. The method according to claim 3, wherein the each respective SDP request includes offer information carried in a hyper text transfer protocol (HTTP) request sent by each of the at least one client, and the HTTP request further includes related information of the each respective SDP request initiated by each of the at least one client this time; and wherein the each respective SDP response includes answer information carried in a HTTP response sent by the service process, and the first verification information includes attribute information included in the answer information; and
after receiving the each respective SDP request, the method further comprises:
creating a mapping entry corresponding to the each respective SDP request, wherein the mapping entry includes related information of the each respective SDP request and the first verification information.

5. The method according to claim 4, wherein verifying the second verification information based on the first verification information comprises:
in response to a mapping entry corresponding to the second verification information existing in the created mapping entry, determining that the verification succeeds.

6. The method according to claim 4, wherein the first verification information includes a timestamp of generating the first verification information, a service process identifier, and a real-time communication (RTC) connection number.

7. The method according to claim 4, wherein the related information of the each respective SDP request includes information of a domain name and a streaming name of a streaming media that is requested.

8. The method according to claim 7, wherein the offer information includes client-supported audio-video coding parameters, and the answer information includes audio-video coding parameters fed back by the server; and
wherein the audio-video coding parameters fed back by the server are live audio-video coding parameters acquired by the server from a live broadcast server based on the information of the domain name and the streaming name in the HTTP request.

9. The method according to claim 4, wherein the UDP connection request includes a binding request based on a simple traversal of UDP through network address translation (STUN) protocol, and the second verification information includes STUN authentication information carried in the binding request.

10. The method according to claim 9, wherein establishing the UDP connection by calling the Connect function comprises:
creating a unique file descriptor for the UDP connection;
binding the unique file descriptor to the UDP port corresponding to the service process;
associating 5-tuple information corresponding to the UDP connection through reversely connecting an address of a peer end; and
associating the 5-tuple information corresponding to the UDP connection with the service process corresponding to the UDP connection based on the unique file descriptor to complete the UDP connection.

11. The method according to claim 10, wherein associating the 5-tuple information corresponding to the UDP connection with the service process corresponding to the UDP connection based on the unique file descriptor to complete the UDP connection comprises:
setting the unique file descriptor as a read-write event monitored by the service process, and setting a read-write event callback function of the unique file descriptor to receive and process subsequent UDP requests corresponding to the unique file descriptor through the read-write event callback function.

12. A server, comprising:
at least one processor; and
memory communicatively coupled to the at least one processor;
wherein the memory stores instructions executable by the at least one processor which, when executed by the at least one processor, cause the at least one processor to perform a method for real-time communication connection; wherein the at least one processor is configured to allocate user datagram protocol (UDP) ports for binding to service processes started on the server, and the service processes are in one-to-one correspondence with the UDP ports; and wherein the method comprises:
receiving each respective session description protocol (SDP) request sent by each of at least one client for resource negotiation from a transmission control protocol (TCP) port of the server;
sending each respective SDP response to each of the at least one client based on the each respective SDP request, wherein the each respective SDP response carries information of a UDP port corresponding to a service process that processes the each respective SDP request;
receiving a UDP connection request sent by a client from the UDP port corresponding to the service process; and
establishing a UDP connection by calling a Connect function.

13. The server according to claim 12, wherein the service process processing the each respective SDP request is one of the service processes locally started on the server which is selected by the server based on a load balancing principle.

14. The server according to claim 12, wherein the each respective SDP response carries first verification information generated by the service process, and the UDP connection request carries second verification information; and
before establishing the UDP connection by calling the Connect function, the method further comprises:
verifying the second verification information based on the first verification information; and
in response to the verification succeeding, performing the establishment of the UDP connection by calling the Connect function.

15. The server according to claim 14, wherein the each respective SDP request includes offer information carried in a hyper text transfer protocol (HTTP) request sent by each of the at least one client, and the HTTP request further includes related information of the each respective SDP request initiated by each of the at least one client this time; and wherein the each respective SDP response includes answer information carried in a HTTP response sent by the service process, and the first verification information includes attribute information included in the answer information; and
after receiving the each respective SDP request, the method further comprises:
creating a mapping entry corresponding to the each respective SDP request, wherein the mapping entry includes related information of the each respective SDP request and the first verification information.

16. The server according to claim 15, wherein verifying the second verification information based on the first verification information comprises:
in response to a mapping entry corresponding to the second verification information existing in the created mapping entry, determining that the verification succeeds.

17. The server according to claim 15, wherein the first verification information includes a timestamp of generating the first verification information, a service process identifier, and a real-time communication (RTC) connection number.

18. The server according to claim 15, wherein the related information of the each respective SDP request includes information of a domain name and a streaming name of a streaming media that is requested.

19. The server according to claim 18, wherein the offer information includes client-supported audio-video coding parameters, and the answer information includes audio-video coding parameters fed back by the server; and
wherein the audio-video coding parameters fed back by the server are live audio-video coding parameters acquired by the server from a live broadcast server based on the information of the domain name and the streaming name in the HTTP request.

20. A non-transitory computer readable storage medium storing a computer program that, when executed by at least one processor, cause the at least one processor to perform a method for real-time communication connection; wherein the at least one processor is configured to allocate user datagram protocol (UDP) ports for binding to service processes started on the server, and the service processes are in one-to-one correspondence with the UDP ports; and wherein the method comprises:
receiving each respective session description protocol (SDP) request sent by each of at least one client for resource negotiation from a transmission control protocol (TCP) port of the server;
sending each respective SDP response to each of the at least one client based on the each respective SDP request, wherein the each respective SDP response carries information of a UDP port corresponding to a service process that processes the each respective SDP request;
receiving a UDP connection request sent by a client from the UDP port corresponding to the service process; and
establishing a UDP connection by calling a Connect function.
